(19) United States
(12) Patent Application Publication
(10) Pub. No.: US 2016/0242183 A1
(43) Pub. Date: Aug. 18, 2016

(54) APPARATUS AND METHOD FOR COEXISTENCE OF LTE-U AND WIFI SERVICES IN UNLICENSED BANDS

(71) Applicant: Electronics and Telecommunications Research Institute, Daejeon (KR)

(72) Inventors: Kyu Min KANG, Daejeon (KR); Seung Keun PARK, Daejeon (KR); Jae Cheol PARK, Daejeon (KR); Jung Sun UM, Daejeon (KR); Sung Jin YOO, Daejeon (KR); Dong Hun LEE, Daejeon (KR); Hoi Yoon JUNG, Daejeon (KR); Su Na CHOI, Daejeon (KR); Sung Hyun HWANG, Daejeon (KR)

(21) Appl. No.: 15/045,764

(22) Filed: Feb. 17, 2016

(30) Foreign Application Priority Data
Feb. 17, 2015 (KR) 10-2015-0023997

(51) Int. Cl. H04W 72/04; H04W 72/08

(52) U.S. Cl. CPC H04W 72/0453; H04W 72/082

(57) ABSTRACT

Disclosed are an apparatus and a method for coexistence of heterogeneous services of a user terminal, which can enhance performance of a wireless communication network by simultaneously providing heterogeneous services such as an LTE-U service and a WiFi service to coexist without signal interference in unlicensed bands through effectively performing selection of a frequency band and selection of a transmission spectrum type in respective service modules of the user terminal.

### CROSS-REFERENCE TO RELATED APPLICATIONS

This application claims priority to and the benefit of Korean Patent Application No. 10-2015-0023997 filed in the Korean Intellectual Property Office on Feb. 17, 2015, the entire contents of which are incorporated herein by reference.

### TECHNICAL FIELD

The present invention relates to an apparatus and a method for simultaneously providing heterogeneous services to coexist in unlicensed bands, and particularly, to an apparatus and a method for coexistence of heterogeneous services of a user terminal, which can enhance performance of a wireless communication network by simultaneously providing heterogeneous services such as an LTE-U service and a WiFi service to coexist without signal interference in unlicensed bands by effectively performing selection of a frequency band and selection of a transmission spectrum type in respective service modules of the user terminal.

### BACKGROUND ART

In recent years, demands for a mobile traffic network and a wireless data service have rapidly increased and an Internet of things (IoT) application service has been expected to extend to all fields of a society. Further, with propagation of a smart device, a request for providing big-size data has continuously increased and a frequency broadband technology for a smooth mobile traffic network and an ultra-speed hotspot service, a frequency sharing technology, and a development of innovative policy and technology for using an electronic wave are required. To this end, recovery and relocation of an optimal frequency for securing a broadband frequency resource have been prosecuted and a spectrum use policy for flexible frequency usage and sharing has been actively prosecuted worldwide. Policy efforts for coping with explosively increased demands of a wireless data service by adding and extending a 5 GHz band as a common frequency usage band for the wireless data service have been in progress from various angles. In the case of United Kingdom, a WiFi service is currently provided at 5150 MHZ to 5350 MHZ (200 MHz bandwidth) and 5470 MHZ to 5725 (255 MHz bandwidth). A WiFi standard which newly emerges requires more frequency bands than in the related art in order to provide a high-speed wireless data service and proposes additionally extending and using a 320 MHz bandwidth.

A mobile service in the related art operates a mobile network in a permission scheme in which a provider is allocated with a specific frequency band and provides a mobile service to a user. However, based on determination that it is difficult to satisfy demands for the mobile service, which explosively increases only by the frequency band allocated in the permission scheme, a trend to increase a mobile service capacity through common frequency usage in urban areasby allocating frequency bands such as 2.3 GHz, and the like utilizing a licensed shared access (LSA) scheme has recently begun for a mobile wide-band service. Further, a trend for a LTE-unlicensed (LTE-U) service that intends to provide a long term evolution (LTE) service by using an unlicensed band has begun based on 3^{rd} generation partnership project (3GPP).

In the case of most smart phones as portable terminals which have been recently marketed, the mobile service (LTE) and the wireless data service (WiFi) have been basically provided. In the mobile service in the related art, since the LTE service and the WiFi service are provided by using different frequency bands, an interference influence exerted from an adjacent channel need not be considered. Therefore, an LTE service module and a WiFi service module mounted in the portable terminal are designed and manufactured without largely considering the interference influence by each other from adjacent channels. However, when heterogeneous services such as the LTE-U service and the WiFi service for the provider are simultaneously provided by using the unlicensed bands such as 5 GHz, and the like in the portable terminal using the unlicensed band afterwards, an operating channel and a transmission output mask need to be effectively operated by considering the interference influence by each other from the adjacent channels for securing performance of a network. For example, since an intensity of an interference signal transferred from the WiFi module that operates in a transmission mode in the adjacent channel is relatively larger than a desired LTE-U received signal intensity transferred from a base station in an LTE-U module that operates in a reception mode in the portable terminal, a case in which the corresponding LTE-U service cannot be sufficiently provided may occur.

### SUMMARY OF THE INVENTION

The present invention has been made in an effort to provide an apparatus and a method for coexistence of heterogeneous services of a user terminal, which use some channels of different groups or include a spectrum mask determiner in a user terminal to control an LTE-U or WiFi transmitting module to select and transmit a spectrum mask of a type other than a received signal among a plurality of spectrum masks to enhance performance a wireless communication network according to calculation of a signal interference level by transmission of a WiFi service signal(alternatively, transmission of an LTE-U service signal) at the time of receiving the LTE-U service signal (alternatively, receiving of a WiFi service signal), in respective service modules for receiving (alternatively, transmitting) an LTE-U service and transmitting (alternatively, receiving) a WiFi service in a user terminal in order to simultaneously provide heterogeneous services such as the LTE-U service and the WiFi service using an adjacent channel of an unlicensed band to coexist without signal interference.

An exemplary embodiment of the present invention provides a wireless communication system for coexistence of heterogeneous services in unlicensed bands, including: a first module providing a first service to a user terminal through wireless communication to a base station relaying the first service in the unlicensed bands; and a second module providing a second service to the user terminal through wireless communication with an AP relaying the second service in the unlicensed bands, in which the first module and the second module provide the corresponding services by using channels determined by the base station and the AP, respectively, and the base station and the AP divide and manage the unlicensed bands into a plurality of subband groups and determine the channels in the subband group for the corresponding service so as to minimize inter-service signal interference by referring to channel state information of the user terminal.

The first service may include an LTE-U service and the second service may include a WiFi service.

The channel state information of the user terminal may include channel information, a received signal level, an intensity of the inter-service signal interference, or a signal-to-noise ratio, for the corresponding service.

The first module and the second module may be embedded in the user terminal or the first module and the second module may be separated from each other to operate as different systems.

Another exemplary embodiment of the present invention provides a wireless communication system for coexistence of heterogeneous services in unlicensed bands, including: a first module providing a first service to a user terminal through wireless communication with a base station relaying the first service in the unlicensed bands; a second module providing a second service to the user terminal through wireless communication with an AP relaying the second service in the unlicensed bands; and a spectrum mask determiner determining a mask for a frequency spectrum of a transmitted signal of the unlicensed band for the corresponding services so as to minimize inter-service signal interference from a received signal in the unlicensed band, with respect to the respective services in the first module and the second module.

The first service may include an LTE-U service and the second service may include a WiFi service.

The spectrum mask determiner may determine a range of a spectrum mask type by calculating an interference signal level which the transmitted signal exerts to the received signal and select one of a plurality of spectrum mask types in the range as the mask for the frequency spectrum of the transmitted signal.

The first module and the second module may provide the corresponding services by using channels determined by the base station and the AP, respectively and the base station and the AP may divide and manage the unlicensed bands into a plurality of subband groups and determine the channels in the subband group for the corresponding service so as to minimize inter-service signal interference by referring to channel state information of the user terminal.

Yet another exemplary embodiment of the present invention provides a wireless communication method for coexistence of heterogeneous services in unlicensed bands in a wireless communication system, including: providing a first service to a user terminal by using a channel determined by a base station relaying the first service in the unlicensed bands by using a first module; and providing a second service to the user terminal by using a channel determined by an AP relaying the second service in the unlicensed bands by using a second module, in which the base station and the AP divide and manage the unlicensed bands into a plurality of subband groups and determine the channels in the subband group for the corresponding service so as to minimize inter-service signal interference by referring to channel state information of the user terminal.

The first service may include an LTE-U service and the second service may include a WiFi service.

The channel state information of the user terminal may include channel information, a received signal level, an intensity of the inter-service signal interference, or a signal-to-noise ratio, for the corresponding service.

The first module and the second module may be embedded in the user terminal or the first module and the second module may be separated from each other to operate as different systems.

Still yet another exemplary embodiment of the present invention provides a wireless communication method for coexistence of heterogeneous services in unlicensed bands of wireless communication systems, including: providing a first service to a user terminal through wireless communication with a base station relaying the first service in the unlicensed bands by using a first module; providing a second service to a user terminal through wireless communication with an AP relaying the second service in the unlicensed bands by using a second module; and determining a mask for a frequency spectrum of a transmitted signal of the unlicensed band for the corresponding services so as to minimize inter-service signal interference from a received signal in the unlicensed band, with respect to the respective services in the first module and the second module.

The first service may include an LTE-U service and the second service may include a WiFi service.

In the determining of the mask, a range of a spectrum mask type may be determined by calculating an interference signal level which the transmitted signal exerts to the received signal and one of a plurality of spectrum mask types in the range may be selected as the mask for the frequency spectrum of the transmitted signal.

The first module and the second module may provide the corresponding services by using channels determined by the base station and the AP, respectively, and the base station and the AP may divide and manage the unlicensed bands into a plurality of subband groups and determine the channels in the subband group for the corresponding service so as to minimize inter-service signal interference by referring to channel state information of the user terminal.

According to exemplary embodiments of the present invention, in an apparatus and a method for coexistence of heterogeneous services of a user terminal, an apparatus and a method for effectively selecting a usable frequency band and an apparatus and a method for selecting a transmission spectrum type are provided in respective service modules for receiving (alternatively, transmitting) an LTE-U service and transmitting (alternatively, receiving) a WiFi service in the user terminal to simultaneously provide heterogeneous services such as the LTE-U service and the WiFi service using an adjacent channel of an unlicensed band to coexist without signal interference, thereby enhancing performance of a wireless communication network.

That is, unlicensed band channels are grouped and thereafter, operating frequency bands which can be used in the respective service modules in the portable terminal are effectively selected to reduce an interference influence which the WiFi service exerts to the LTE-U service and reduce an interference influence which the LTE-U service exerts to the WiFi service.

Multiple spectrum masks are configured so as to diversely apply spectrum masks in a WiFi module and an LTE-U module and a method for selecting transmission spectrum types which can be used in the respective service modules (LTE-U and WiFi modules) is applied to effectively enhance performance of an overall network which is operated in the unlicensed band.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram for describing a wireless communication system environment providing heterogeneous services (LTE-U and WiFi) according to an exemplary embodiment of the present invention.

FIG. 2 is a diagram for describing a device of a user terminal including an LTE-U module and a WiFi module for coexistence of heterogeneous services according to an exemplary embodiment of the present invention.

FIG. 3 is an exemplary diagram of group unit classification of unlicensed band channels for application in the device of the user terminal of FIG. 2.

FIG. 4 is a diagram for describing a device of a user terminal further including a unit determining an unlicensed band frequency spectrum mask type permissible in the device of the user terminal of FIG. 2 according to another exemplary embodiment of the present invention.

FIG. 5 is an exemplary diagram of a single frequency spectrum mask used in a WiFi system in the related art.

FIG. 6 is an exemplary diagram of the unlicensed band frequency spectrum mask type permissible for application in FIG. 4.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to the accompanying drawings. In this case, in respective drawings, like reference numerals refer to like elements. Further, a detailed description of an already known function and/or configuration will be omitted. In contents disclosed hereinbelow, a part required for understanding an operation according to various exemplary embodiments will be described in priority and a description of elements which may obscure the gist of the present invention will be omitted. Further, some components of the drawings may be enlarged, omitted, or schematically illustrated. An actual size is not fully reflected on the size of each component and therefore, contents disclosed herein are not limited by relative sizes or intervals of the components drawn in the respective drawings.

First, in the present invention, for easy description, as heterogeneous services which coexist in unlicensed bands such as 5 GHz, and the like, a long term evolution-unlicensed (LTE-U) service and a wireless fidelity (WiFi) service will be described as an example. However, they are just an example and an apparatus and a method for providing heterogeneous services which coexist in order to efficiently use limited frequency resources like the present invention may be similarly applied to unlicensed bands in other frequency bands and similarly applied to the case of providing two or more wireless communication services to coexist by not the LTE-U or WiFi but other wireless communication protocols.

In the present invention, a user terminal as a terminal that may receive all service in the unlicensed bands, such as the LTE-U service and the WiFi service other than an LTE service in licensed bands includes portable terminals including a smart phone, a tablet PC, a notebook PC, and the like receiving a wireless communication service by using a mobile communication (e.g., WCDMA, LTE, and the like) network, a wireless Internet (e.g., WiBro, WiFi, and the like), and other wireless networks through a base station. However, the present invention is not limited thereto and in some cases, the user terminal may include all other electronic devices receiving the wireless communication service by using other wireless networks. In the present invention, the user terminal may receive the services by accessing macro networks (alternatively, a core network) such as the Internet, the mobile communication network, and the like by relay of the base station for providing the LTE-U service described belowor an access point (AP) for providing a WiFi wireless LAN service.

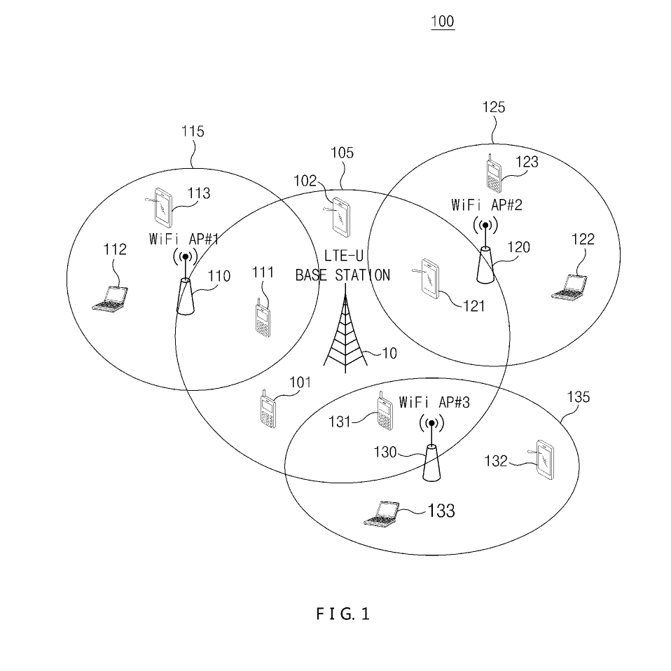

FIG. 1 is a diagram for describing an environment of a wireless communication system 100, which provides heterogeneous services (LTE-U and WiFi) according to an exemplary embodiment of the present invention.

Referring to FIG. 1, it is assumed that the wireless communication system 100 according to the exemplary embodiment of the present invention includes a base station 10 for providing an LTE-U service to user terminals 101, 102, 111, 121, and 131 in a corresponding small cell coverage 150 and three access points (APs) 110, 120, and 130 installed around the base station 10 to provide a WiFi wireless LAN service. In some cases, more APs may be installed around the base station 10.

In FIG. 1, a first AP 110 may provide the WiFi wireless LAN service to the user terminals 111, 112, and 113 in the corresponding small cell coverage 115, a second AP 120 may provide the WiFi wireless LAN service to the user terminals 121, 122, and 123 in the corresponding small cell coverage 125, and a third AP 130 may provide the WiFi wireless LAN service to the user terminals 131, 132, and 133 in the corresponding small cell coverage 135. That is, the user terminals 111, 121, and 131 may receive an LTE-U service from an LTE-U base station 10 and simultaneously, receive the WiFi wireless LAN service from each of the first AP 110, the second AP 120, and the third AP 130 in unlicensed bands.

For example, it is considered that when the user terminal 131 receives the LTE-U service according to relay of the LTE-U base station 10 in the cell coverage 135 of the LTE-U base station 10 in the unlicensed bands and simultaneously, receives the WiFi wireless LAN service according to relay of the third AP 130 in the cell coverage 135 of the third AP 130, the user terminal 131 operates in a transmission mode for the WiFi service while operating in a reception mode for the LTE-U service. In this case, assuming that the LTE-U and WiFi services are separately operated in an adjacent frequency band in the unlicensed bands, an interference signal intensity applied to a receiving unit of an LTE-U module from a transmitting unit of a WiFi module is still larger than that of an LTE-U received signal transferred to the receiving unit of the LTE-U module from the LTE-U base station 10 in the user terminal 131, and as a result, the corresponding LTE-U service may not be sufficiently provided.

On the contrary, it is considered that the user terminal 131 operates in the reception mode for the WiFi service while operating in the transmission mode for the LTE-U service. In this case, an interference signal intensity applied to the receiving unit of the WiFi module from the transmitting unit of the LTE-U module is still larger than that of a WiFi received signal transferred to the receiving unit of the WiFi module from the third AP 130 in the user terminal 131, and as a result, the corresponding WiFi service may not be sufficiently provided.

In order to reduce such an interference influence, first, the corresponding user terminal 131 is allowed to receive both the LTE-U service and the WiFi service in the unlicensed bands or second, appropriately classifies frequency bands which may be used by each AP, each base station, and each user terminal in coverage of the LTE-U service and coverage of the WiFi service to the LTE-U service and the WiFi service in order to provide both the LTE-U service and the WiFi service in the unlicensed bands to perform channel management, thereby preventing a mutual interference influence by an adjacent channel leakage ratio (ACLR) from being serious. Further, a mask which is stricter than a frequency spectrum mask of a transmitted signal is applied as necessary to improve performance of an overall network.

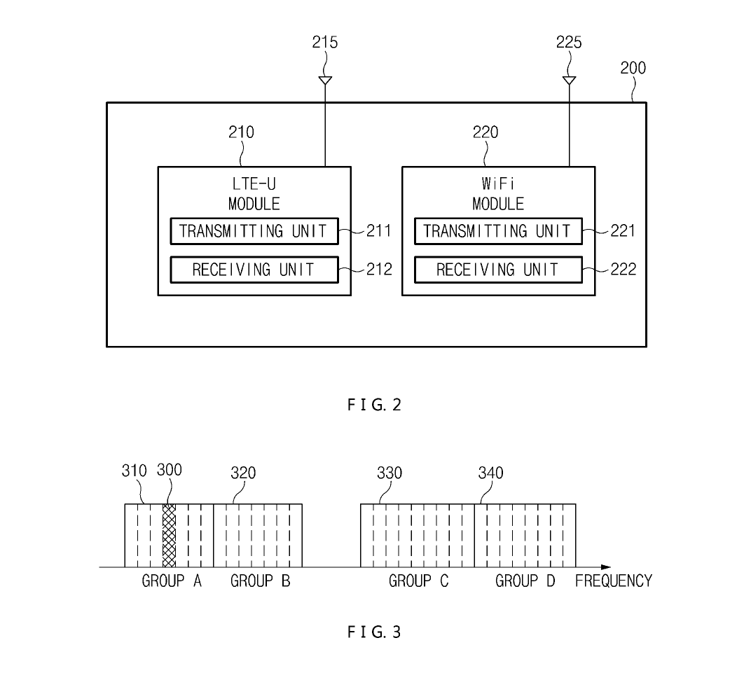

FIG. 2 is a diagram for describing a device 200 of a user terminal for coexistence of heterogeneous services according to an exemplary embodiment of the present invention.

The device 200 of the user terminal according to the exemplary embodiment of the present invention includes an LTE-U module 210 and a WiFi module 220, and the LTE-U module 210 transmits/receives a signal for the LTE-U service through an LTE-U antenna 215 in connection with an LTE-U antenna 215 to provide the LTE-U service to the user terminal and the WiFi module 220 transmits/receives a signal for the WiFi service through a WiFi antenna 225 in connection with a WiFi antenna 225 to provide the WiFi service to the user terminal.

The LTE-U module 210 includes a transmitting unit 211 for transmitting a transmitted signal through the antenna 215 at a corresponding unlicensed band frequency by modulating the LTE-U service transmitted signal and a receiving unit 212 for receiving the corresponding service data by demodulating the LTE-U service signal at the unlicensed band frequency, which is received through the antenna 215. Further, the WiFi module 220 includes a transmitting unit 221 for transmitting a transmitted signal through the antenna 225 at the corresponding unlicensed band frequency by modulating the WiFi service transmitted signal and a receiving unit 222 for receiving the corresponding service data by demodulating the WiFi service signal at the unlicensed band frequency, which is received through the antenna 225.

Herein, it is illustrated that the LTE-U antenna 215 and the WiFi antenna 225 are provided independently from each other, but the LTE-U antenna 215 and the WiFi antenna 225 are not limited thereto and the LTE-U antenna 215 and the WiFi antenna 225 may be designed and manufactured in one structure to transmit/receive signals for two or more services according to a design method.

Meanwhile, in a wireless network in the related art, different frequency bands are just used and operated with respect to the LTE-U service signal and the WiFi service signal and a portable terminal in the related art is designed and manufactured without largely considering the mutual interference influence by the adjacent channel of each service.

In such a case, as described above, when the user terminal receives two or more heterogeneous services, a signal of the module that operates in the transmission mode interferes with a signal received by the module that operates in the reception mode, and as a result, the received service may not be normally performed. Therefore, in the present invention, when the LTE service and the WiFi service are simultaneously operated by using the adjacent channel in the unlicensed bands, the LTE-U module 210 and the WiFi module 220 of the device 200 of the user terminal may operate by effectively operating channel selection and management for coexistence without influencing the performances of the respective services.

FIG. 3 is an exemplary diagram of group unit classification of unlicensed band channels for application in the device 200 of the user terminal of FIG. 2.

FIG. 3 illustrates an example in which in order to simultaneously provide the LTE-U service and the WiFi service in the unlicensed bands, the LTE-U base station 10 or the WiFi APs 110, 120, and 130 appropriately classify and manage available frequencies in the unlicensed bands into multiple groups. The LTE-U base station 10 or the WiFi APs 110, 120, and 130 may control the respective services to be connectedwith the user terminal through channels (e.g., a channel having the largest difference in frequency) of different groups with respect to each service in order to reduce the interference influence by the adjacent channel leakage ratio (ACLR) among the service signals through such unlicensed band group management.

For example, in FIG. 3, a management target unlicensed band is divided into a plurality of subband groups A, B, C, and D which are adjacent to each other to be managed. FIG. 3 illustrates that subband groups A and B are constituted by 7 frequency channels and subband groups C and D are constituted by 9 and 8 frequency channels, respectively. Such a management target unlicensed band is divided into the plurality of subband groups including one or more channels to be managed.

As one example, the LTE-U base station 10 provides the LTE-U service by using a channel 300 among the subbands of group A, and as a result, when the LTE-U base station 10 receives the LTE-U service through the LTE-U module 210 of the user terminal, the LTE-U base station 10 provides the WiFi service by using another channel 310 among the subbands of group A in any one AP, and as a result, when the LTE-U base station 10 receives the WiFi service through the WiFi module 220 of the user terminal, the service may not be normally performed due to the interference influence by the ACLR. On the contrary, when the WiFi service is provided by using a channel among subband group D having the largest difference from the subband group A in the AP, an inter-service interference influence is small, and as a result, the respective services may be smoothly provided.

Therefore, the LTE-U base station 10 or the WiFi APs 110, 120, and 130 may control the respective services to be connected with the user terminal through channels (e.g., a channel having the largest difference in frequency) of different groups through the unlicensed band group management in order to reduce the interference influence by the ACLR between the LTE-service signal and the WiFi service signal in the unlicensed bands.

That is, the LTE-U base station 10 may determine a subband group in the unlicensed bands for the LTE-U service and determine any one channel in the subband group in order to select the channels (e.g., a channel having the largest difference in frequency) of different groups in which inter-service signal interference is minimized according to channel state information of the user terminal, such as WiFi channel information of the user terminal, an LTE-U service received signal level in LTE-U service coverage 105, a signal interference intensity with the LTE-U received signal of the WiFi transmitted signal by the ACLR transferred to the LTE-U module 210 from the WiFi module 220, a signal-to-noise ratio of the LTE-U service received signal required for the corresponding LTE-U service, and the like. The channel state information of the user terminal may be received through a request of the user terminal which accesses the LTE-U base station 10.

Similarly, the WiFi APs 110, 120, and 130 may determine a subband group in the unlicensed bands for the WiFi service and determine any one channel in the subband group in order to select the channels (e.g., a channel having the largest difference in frequency) of different groups in which inter-service signal interference is minimized according to channel state information of the user terminal, such as LTE-U channel information of the user terminal, a WiFi service received signal level in WiFi service coverage 115/125/135, a signal interference intensity with the WiFi received signal of the LTE-U transmitted signal by the ACLR transferred to the WiFi module 210 from the LTE-U module 220, a signal-to-noise ratio of the WiFi service received signal required for the corresponding WiFi service, and the like. The channel state information of the user terminal may be received through a request of the user terminal which accesses the WiFi APs 110, 120, and 130.

Herein, a case in which the LTE-U module 210 and the WiFi module 220 are provided in the user terminal is assumed and described, but the present invention is not limited thereto. That is, although the modules are not embedded in the same terminal, when a module or a system for the LTE-U service or a module or a system for a system for the WiFi service is separated and thus installed to be spaced from the same building or household by a closely adjacent distance to operate as different systems, operating an operating channel of the LTE-U service and an operating channel of the WiFi service in different groups are efficient to improve the performance of the overall network in order to protect the respective services.

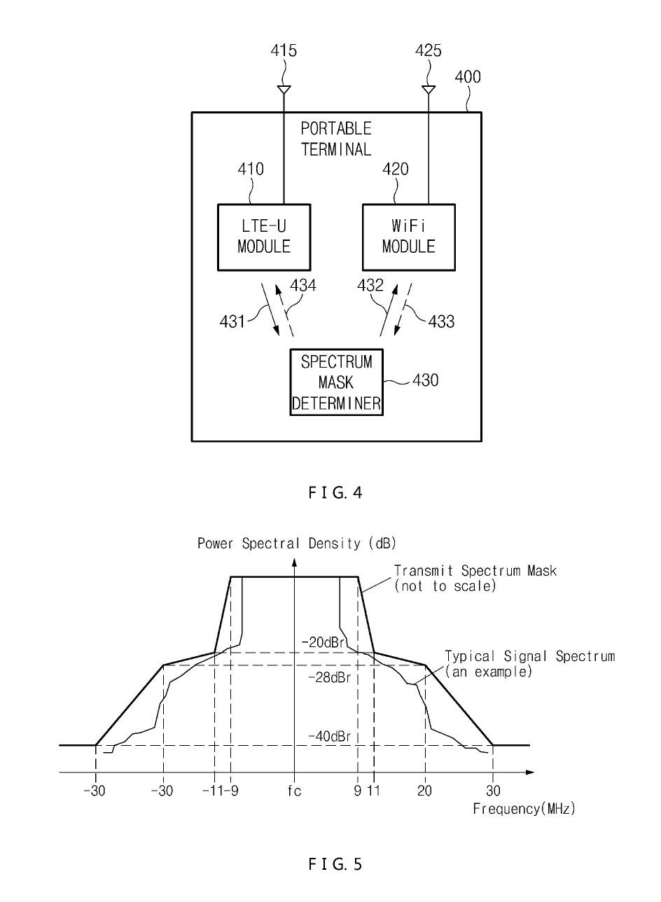

FIG. 4 is a diagram for describing a device 400 of a user terminal further including a unit 430 determining an unlicensed band frequency spectrum mask type permissible in the device 200 of the user terminal of FIG. 2 according to another exemplary embodiment of the present invention.

Referring to FIG. 4, the device 400 of the user terminal according to another exemplary embodiment of the present invention includes an LTE-U module 410 and a WiFi module 420, and a spectrum mask determiner 430, and the LTE-U module 410 transmits/receives the signal for the LTE-U service through an LTE-U antenna 415 in connection with the LTE-U antenna 415 to provide the LTE-U service to the user terminal and the WiFi module 420 transmits/receives the signal for the WiFi service through a WiFi antenna 425 is connection with the WiFi antenna 425 to provide the WiFi service to the user terminal.

Herein, each of the LTE-U module 410 and the WiFi module 420 may include a transmitting unit and a receiving unit and operating schemes thereof may be similar to operating schemes of the LTE-U module 210 and the WiFi module 220 of FIG. 2. However, the LTE-U module 410 and the WiFi module 420 perform additional corresponding operations in association with a case in which the spectrum mask determiner 430 determines an allowable unlicensed band frequency spectrum mask.

Even herein, it is illustrated that the LTE-U antenna 415 and the WiFi antenna 425 are provided independently from each other, but the LTE-U antenna 415 and the WiFi antenna 425 are not limited thereto and the LTE-U antenna 415 and the WiFi antenna 425 may be designed and manufactured in one structure to transmit/receive signals for two or more services according to a design method.

The spectrum mask determiner 430 calculates an interference signal level which a WiFi channel (e.g., a transmitting (uplink) channel) of an adjacent group which the WiFi module 420 uses for the WiFi service applies to an LTE-U channel by using a predetermined algorithm such as comparison with a reference signal, or the like from a signal 431 of an LTE-U channel, which is received by an LTE-U channel (e.g., a receiving (downlink) channel) for the LTE-U service through the LTE-U module 410 and thereafter, determines a range 432 of a usable spectrum mask type so as to minimize an inter-service signal interference influence in the WiFi module 420 according to the calculated interference signal level. According to the range 432 of the spectrum mask type determined by the spectrum mask determiner 430, the WiFi module 420 selects the spectrum mask type within the corresponding range and applies the selected spectrum mask type to the WiFi channel (e.g., transmitting (uplink) channel) to safely provide the LTE-U service in the corresponding channel.

Similarly thereto, the spectrum mask determiner 430 calculates an interference signal level which an LTE-U channel (e.g., a transmitting (uplink) channel) of an adjacent group which the LTE-U module 410 uses for the LTE-U service applies to the WiFi channel by using a predetermined algorithm such as comparison with a reference signal, or the like from a signal 433 of the WiFi channel, which is received by the WiFi channel (e.g., a receiving (downlink) channel) for the WiFi service through the WiFi module 420 and thereafter, determines a range 434 of a usable spectrum mask type so as to minimize an inter-service signal interference influence in the LTE-U module 410 according to the calculated interference signal level. According to the range 432 of the spectrum mask type determined by the spectrum mask determiner 434, the LTE-U module 410 selects the spectrum mask type within the corresponding range and applies the selected spectrum mask type to the LTE-U channel (e.g., transmitting (uplink) channel) to safely provide the WiFi service in the corresponding channel

The unlicensed band frequency spectrum mask type which the respective service modules 410 and 420 presented in the present invention may use for the transmitted signal is selectively applied as described above to effectively enhance the performance of the overall network which operates in the unlicensed bands.

In the WiFi system in the related art, when an orthogonal frequency division multiplexing (OFDM) signal in a 20 MHz bandwidth is transmitted, the transmitted signal is transmitted in a single frequency spectrum mask type which is symmetric to a center frequency fc as illustrated in FIG. 5. When the WiFi system is operated based on a simplified spectrum mask, since an interference influence is exerted to the signal of the LTE-U system operated in an adjacent channel or another group channel in the unlicensed bands, a situation in which intended performance may not be obtained in the LTE-U system may occur. Similarly, when the spectrum mask presented in a current standard is applied to the transmitted signal as it is even in the LTE-U system, the interference influence is exerted to the WiFi system operated in another frequency band (group) to degrade performance of a WiFi network.

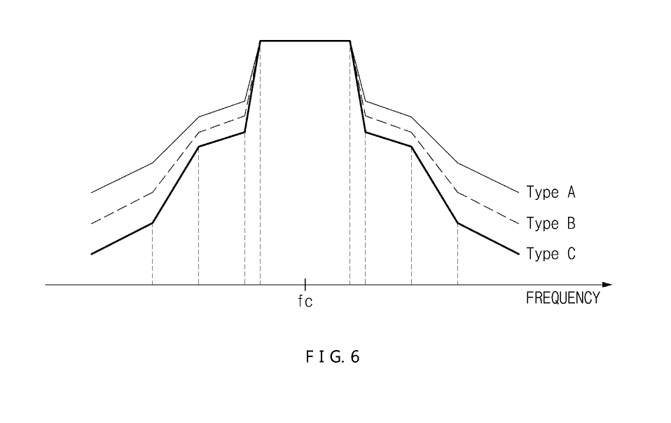

Therefore, in the present invention, according to the range of the spectrum mask type which the spectrum mask determiner 430 determines so as to minimize the interference influence from each service received channel signal, the LTE-U module 410 or the WiFi module 420 selects any one of a plurality of spectrum mask types A, B, and C and thus applies the selected mask type to the transmitting channel as illustrated in FIG. 6 to safely provide the LTE-U or WiFi service in the corresponding channel Three spectrum mask types are illustrated in FIG. 6 for easy description, but the spectrum mask types are not limited thereto and the overall network may be operated by increasing or decreasing the number of spectrum mask types required for operating the overall network. The spectrum mask type may be variously determined according to a frequency use width of the corresponding transmitted signal from the center frequency fc at predetermined levels such as signal levels −20, −28, −40 dBr, and the like.

For example, a case in which one user terminal 131 operates both in an LTE-U reception mode and a WiFi transmission mode is described. In this case, it is assumed that the LTE-U service uses one frequency channel 300 of group A (e.g., uses spectrum mask type A) and the WiFi service selects and operates spectrum mask type A of FIG. 5 in a frequency channel 320 of group B. In this case, since the interference influence exerted to the received signal by the transmitted signal from the WiFi module 420 is still larger than the received signal intensity from the LTE-U base station 10, the LTE-U module 410 may not sufficiently provide the corresponding LTE-U service in the user terminal 131. In this case, when spectrum mask type B or C is selected and applied as the WiFi transmission spectrum mask type according to the range (e.g., a range including types B and C) of the spectrum mask type determined by the spectrum mask determiner 430, unlike the mask type used in the LTE-U service, the LTE-U module 310 undergoes less interference influence by the WiFi service which operates in channel 320 (similarly even in the channel 330 or 340 of group C or D) of group B and may sufficiently receive the LTE-U service as intended at first.

Similarly, even when one user terminal 131 operates both in the LTE-U transmission mode and the WiFi reception mode, according to a principle similar to above, one appropriate type among multiple spectrum mask types is selected and applied to the LTE-U transmitted signal to reduce the interference influence by the LTE-U service, thereby smoothly providing the WiFi service as intended at first.

As described above, according to the operating scheme in the device 200/400 of the user terminal for coexistence of the heterogeneous services in the present invention, in respective service modules for receiving (alternatively, transmitting) the LTE-U service and transmitting (alternatively, receiving) the WiFi service in the user terminal, the frequency channel among a plurality of subgroups is effectively selected and the transmission spectrum type is appropriately selected to simultaneously provide the heterogeneous services such as the LTE-U service and the WiFi service using the adjacent channel of the unlicensed band to coexist without signal interference, thereby enhancing performance of a wireless communication network. That is, unlicensed band channels are grouped and thereafter, operating frequency bands which can be used in the respective service modules in the portable terminal are effectively selected to reduce an interference influence which the WiFi service exerts to the LTE-U service and reduce an interference influence which the LTE-U service exerts to the WiFi service. Further, multiple spectrum masks are configured so as to diversely apply spectrum masks in a WiFi module and an LTE-U module and a method for selecting transmission spectrum types which can be used in the respective service modules (LTE-U and WiFi modules) is applied to effectively enhance performance of an overall network which is operated in the unlicensed band.

The specified matters and limited embodiments and drawings such as specific components in the present invention have been disclosed for illustrative purposes, but are not limited thereto, and those skilled in the art will appreciate that various modifications and changes can be made in the art to which the present invention belongs, within the scope without departing from an essential characteristic of the present invention. The spirit of the present invention should not be defined only by the described exemplary embodiments, and it should be appreciated that claims to be described below and all technical spirits which are modified evenly or equivalently to the appended claims of the present invention.

What is claimed is:

1. A wireless communication system for coexistence of heterogeneous services in unlicensed bands, the wireless communication system comprising:
a first module providing a first service to a user terminal through wireless communication to a base station relaying the first service in the unlicensed bands; and
a second module providing a second service to the user terminal through wireless communication with an AP relaying the second service in the unlicensed bands,
wherein the first module and the second module provide the corresponding services by using channels determined by the base station and the AP, respectively, and
the base station and the AP divide and manage the unlicensed bands into a plurality of subband groups and determine the channels in the subband group for the corresponding service so as to minimize inter-service signal interference by referring to channel state information of the user terminal.

2. The wireless communication system of claim 1, wherein the first service includes an LTE-U service and the second service includes a WiFi service.

3. The wireless communication system of claim 1, wherein the channel state information of the user terminal includes channel information, a received signal level, an intensity of the inter-service signal interference, or a signal-to-noise ratio, for the corresponding service.

4. The wireless communication system of claim 1, wherein the first module and the second module are embedded in the user terminal.

5. The wireless communication system of claim 1, wherein the first module and the second module are separated from each other to operate as different systems.

6. A wireless communication system for coexistence of heterogeneous services in unlicensed bands, the wireless communication system comprising:
a first module providing a first service to a user terminal through wireless communication with a base station relaying the first service in the unlicensed bands;
a second module providing a second service to the user terminal through wireless communication with an AP relaying the second service in the unlicensed bands; and
a spectrum mask determiner determining a mask for a frequency spectrum of a transmitted signal of the unlicensed band for the corresponding services so as to minimize inter-service signal interference from a received signal in the unlicensed band, with respect to the respective services in the first module and the second module.

7. The wireless communication system of claim 6, wherein the first service includes an LTE-U service and the second service includes a WiFi service.

8. The wireless communication system of claim 6, wherein the spectrum mask determiner determines a range of a spectrum mask type by calculating an interference signal level which the transmitted signal exerts to the received signal and selects one of a plurality of spectrum mask types in the range as the mask for the frequency spectrum of the transmitted signal.

9. The wireless communication system of claim 6, wherein the first module and the second module provide the corresponding services by using channels determined by the base station and the AP, respectively, and the base station and the AP divide and manage the unlicensed bands into a plurality of subband groups and determine the channels in the subband group for the corresponding service so as to minimize inter-service signal interference by referring to channel state information of the user terminal.

10. A wireless communication method for coexistence of heterogeneous services in unlicensed bands in a wireless communication system, the wireless communication method comprising:
providing a first service to a user terminal by using a channel determined by a base station relaying the first service in the unlicensed bands by using a first module; and
providing a second service to the user terminal by using a channel determined by an AP relaying the second service in the unlicensed bands by using a second module,
wherein the base station and the AP divide and manage the unlicensed bands into a plurality of subband groups and determine the channels in the subband group for the corresponding service so as to minimize inter-service signal interference by referring to channel state information of the user terminal.

11. The wireless communication method of claim 10, wherein the first service includes an LTE-U service and the second service includes a WiFi service.

12. The wireless communication method of claim 10, wherein the channel state information of the user terminal includes channel information, a received signal level, an intensity of the inter-service signal interference, or a signal-to-noise ratio, for the corresponding service.

13. The wireless communication method of claim 10, wherein the first module and the second module are embedded in the user terminal.

14. The wireless communication method of claim 10, wherein the first module and the second module are separated from each other to operate as different systems.

15. A wireless communication method for coexistence of heterogeneous services in unlicensed bands in a wireless communication system, the wireless communication method comprising:
providing a first service to a user terminal through wireless communication with a base station relaying the first service in the unlicensed bands by using a first module;
providing a second service to the user terminal through wireless communication with an AP relaying the second service in the unlicensed bands by using a second module; and
determining a mask for a frequency spectrum of a transmitted signal of the unlicensed band for the corresponding services so as to minimize inter-service signal interference from a received signal in the unlicensed band, with respect to the respective services in the first module and the second module.

16. The wireless communication method of claim 15, wherein the first service includes an LTE-U service and the second service includes a WiFi service.

17. The wireless communication method of claim 15, wherein in the determining of the mask, a range of a spectrum mask type is determined by calculating an interference signal level which the transmitted signal exerts to the received signal and one of a plurality of spectrum mask types in the range is selected as the mask for the frequency spectrum of the transmitted signal.

18. The wireless communication method of claim 15, wherein the first module and the second module provide the corresponding services by using channels determined by the base station and the AP, respectively and the base station and the AP divide and manage the unlicensed bands into a plurality of subband groups and determine the channels in the subband group for the corresponding service so as to minimize inter-service signal interference by referring to channel state information of the user terminal.
